(19) United States
(12) Patent Application Publication
(10) Pub. No.: US 2026/0139552 A1
(43) Pub. Date: May 21, 2026

(54) WELLBORE TUBULAR STRING HAVING THREADED CONNECTIONS

(71) Applicant: Sooner Inc., Houston, TX (US)

(72) Inventor: Terry Dobson, Jr., Houston, TX (US)

(73) Assignee: Sooner Inc., Houston, TX (US)

(21) Appl. No.: 19/389,357

(22) Filed: Nov. 14, 2025

Related U.S. Application Data
(60) Provisional application No. 63/721,844, filed on Nov. 18, 2024.

(51) Int. Cl. E21B 17/042; F16L 15/00

(52) U.S. Cl. CPC E21B 17/042; F16L 15/001

(57) ABSTRACT

A downhole tubular string is made up of pins connected to one another with annular couplings. Threads on opposing ends of each pin engage threads in the coupling to form a threaded connection. Before assembling the string, portions of the threads on the pins and coupling are inspected to ensure compliance with a designated specification. The portions inspected are fully crested, and the portions inspected on the coupling engage the portions that are inspected on the pins. The threads on the coupling are strategically dimensioned so that a torque for threading a pin onto the coupling mill end exceeds a torque for threading a pin onto the coupling field end. An interface where pin ends abut one another in the coupling is offset from a coupling midpoint to contribute to the difference in torque between making up the field and mill ends.

### CROSS-REFERENCE TO RELATED APPLICATION

This application claims priority to and the benefit of co-pending U.S. Provisional Application Ser. No. 63/721,844, filed Nov. 18, 2024, the full disclosure of which is incorporated by reference herein in its entirety and for all purposes.

### BACKGROUND OF THE INVENTION

### 1. Field of Invention

The present disclosure relates to fabricating a tubular string made up of tubulars and couplings and forming threaded connections between the tubulars and couplings that are substantially identical to one another.

### 2. Description of Prior Art

Oilfield tubulars, such as casing strings, caissons, production strings, are often formed by multiple tubular segments joined at their ends by a threaded connection. Some connections are formed by mating threads on a box end of one of the tubulars with a pin end on the adjacent tubular. Other connections have a pin-to-pin connection by employing annular couplings having inner threads that engage threads on outer surface of pin ends of the tubulars. The annular couplings often include a shoulder formed along the inner circumference, which is wedged between the pin ends when the connection is made up. In couplings without an inner shoulder, the pin ends typically abut one another at a mid-point in the coupling.

The strings are typically formed by inserting a first tubular into a wellbore and connecting a second tubular onto the upper end of the first tubular. The first and second tubulars are connected by engaging threads on a lower pin end of the second tubular with threads in a coupling on an upper end of the first tubular. These threads are engaged by rotating the second tubular and anchoring the first tubular with slips in the rotary table to prevent its rotation. The couplings are usually attached to one end of each tubular prior to inserting the tubular into the wellbore. The string is formed by adding a designated number of tubular joints in the same manner forming connections between adjacent tubulars. To ensure compliance with structural and pressure design standards, such as those American Petroleum Institute Specification 5CT, wellbore operators often monitor the torque exerted onto the tubular being rotated. When threads on couplings and tubulars are within tolerance values and without surface irregularities, the torque increases slightly exponentially with rotation of the tubular until the connection is fully formed, after which the torque increases with little to no rotation of the tubular. Whereas when threads are not within tolerance values or have surface irregularities, the torque to form the connection is increased, and full “make-up” of the connection may sometimes not be achieved. A coupling may be removed if there is enough variance in the monitored torque, because excursions from expected torque values can identify if a pressure seal is formed in the threaded connection or if the threaded connection is defective. Unacceptable variations in torque are often caused due to an inconsistently formed threaded connection. As such, a need exists to create threaded connections in downhole tubular strings that are consistent and substantially identical with one another.

### SUMMARY OF THE INVENTION

Disclosed herein is a method of wellbore operations that includes obtaining annular couplings with threaded lengths having designated portions that have each passed an inspection, forming a tubular string by threadingly engaging the threaded lengths of the couplings with threaded ends of tubular members, and inserting the tubular string into the wellbore. In an example, the threaded lengths each have a thread formed on an inner surface of the annular coupling, and the inspection includes comparing a diameter of the thread with a specified diameter of the thread. In an alternative, the threaded lengths are first threaded lengths, wherein the designated portions have first designated portions, where second threaded lengths with second designated portions are on threaded ends of the tubular members, and where the second designated portions have each passed the inspection. In another alternative, the threaded lengths are first threaded lengths, the designated portions are first designated portions, second threaded lengths with second designated portions are on threaded ends of the tubular members, and the first and second designated portions are in threaded engagement with one another when the tubular string is formed. The threads on the designated portions are optionally fully crested threads. In an embodiment, the couplings have a mill end and a field end, and the step of forming the tubular string includes applying a first torque to mount the mill end of a one of the couplings with a mill end of a one of the tubular members, applying a second torque to mount the field end of the coupling with a field end of another one of the tubular members, and the first torque exceeds the second torque; further in this embodiment, an interference between threads on the mill end of the coupling and mill end of a one of the tubulars alternatively exceeds an interference between threads on the field end of coupling and the field end of the another one of the tubular members. In another alternative to this embodiment, the method further includes applying a first pipe compound to the threads on the mill end of the coupling and applying a second pipe compound to the threads on the field end of the coupling, where a viscosity of the first pipe compound exceeds a viscosity of the second pipe compound. In yet another alternative, a taper of the threads on the mill end of the coupling differs from a taper of the threads on the mill end of a one of the tubulars, and where a taper of the threads on the field end of coupling differs from a taper of the threads on the field end of the another one of the tubular members. Alternatively, portions of the tubular members within the couplings interface one another at an axial location that is offset from an axial midpoint of the coupling. In another example, the designated portion coincides with a portion of the thread length where a pressure barrier is formed in an interface between threads on the coupling and threads on the pin.

Another method of wellbore operations is disclosed that includes obtaining annular coupling having an inner thread with a thread length, gathering information about the thread along a designated portion of the thread length, accepting the annular coupling if the information complies with standards from a designated specification, repeating the above steps to obtain a multiplicity of accepted annular couplings, forming a tubular string with annular couplings, and inserting the tubular string into the wellbore. In an example, the tubular string includes tubular members threadingly engaged to one another with the accepted annular couplings. Further in this example, threads having thread lengths are formed on ends of the tubulars, the method further includes gathering information about each of the threads on the tubulars along portions of the thread lengths on the tubulars and accepting tubulars having threads that comply with the standards and using only tubulars to form the tubular string. Further optionally, the portions of the thread lengths on the tubulars mesh with the designated portion of the thread length on the coupling when attached to one another. In an embodiment, each of the couplings has a mill end and a field end, and a torque applied to engage a tubular to the mill end exceeds a torque applied to engage another tubular to the field end. Alternatively, each of the couplings has a mill end and a field end, a mill end tubular is attached to the mill end and a field end tubular is attached to the field end, and the mill end tubular and field end tubular abut one another inside the coupling at an interface that is between a centerline of the coupling and the field end. Examples exist in which the designated portion of the thread length is where the thread is fully crested. Further optionally, the designated portion of the thread length is proximate a centerline of the coupling. In an alternative, the designated specification is API Specification 5CT/5B.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side partial sectional view of installing an example of a tubular string with couplings being installed in a wellbore.

FIG. 2 is a side sectional view of an example of a coupling of FIG. 1.

FIG. 3 is a side sectional detailed view of a portion of the coupling of FIG. 2.

FIG. 4 is a partial sectional view of an example of inspecting threads on an inner surface of a coupling.

FIG. 5 is a partial sectional view of an example of inspecting threads on an outer surface of a pin end.

While subject matter is described in connection with embodiments disclosed herein, it will be understood that the scope of the present disclosure is not limited to any particular embodiment. On the contrary, it is intended to cover all alternatives, modifications, and equivalents thereof.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of a cited magnitude. In an embodiment, the term “substantially” includes +/−5% of a cited magnitude, comparison, or description. In an embodiment, usage of the term “generally” includes +/−10% of a cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

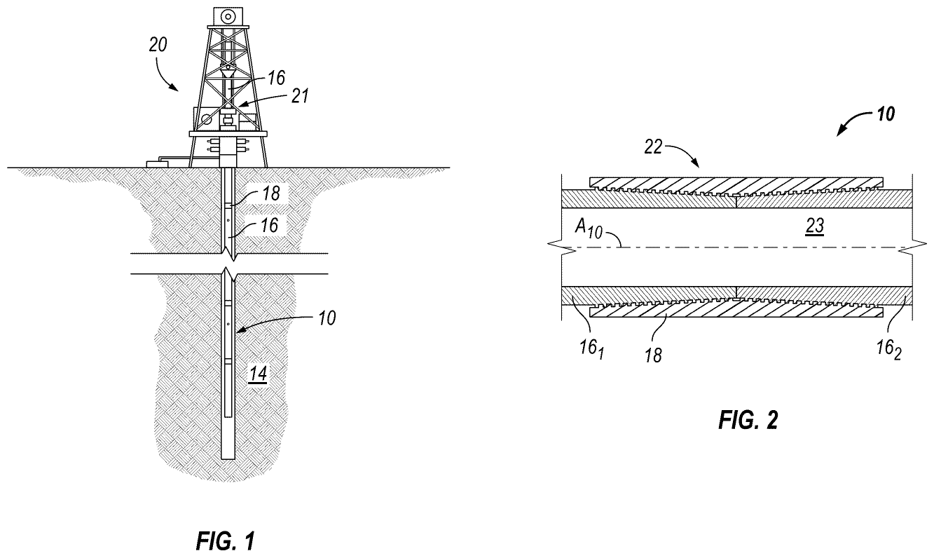

In FIG. 1 is a partial side sectional view of an example of a tubular string 10 being installed inside of a wellbore 12 shown intersecting a formation 14. The tubular string 10 is made-up of a number of casing joints 16 (also referred to herein as tubulars) connected at their respective ends to one another by couplings 18. On surface, a derrick 20 is installed over an opening of wellbore 12 for supporting the installation operation. Supported on derrick 20 are tongs 21 for rotating a coupling 18 and/or tubulars 16 with respect to one another for making up the string 10. Illustrated in a side sectional view in FIG. 2 is an example of a threaded connection 22 formed by the operation depicted in FIG. 1. The threaded connection 22 is formed by attaching adjacent tubulars 16_{1, 2} to one another by threading opposing ends of the tubulars 16_{1, 2} to an annular coupling 18. The ends of the tubulars 16_{1, 2} project into opposite ends of a bore shown extending along an axis A₁₀ of the coupling 18.

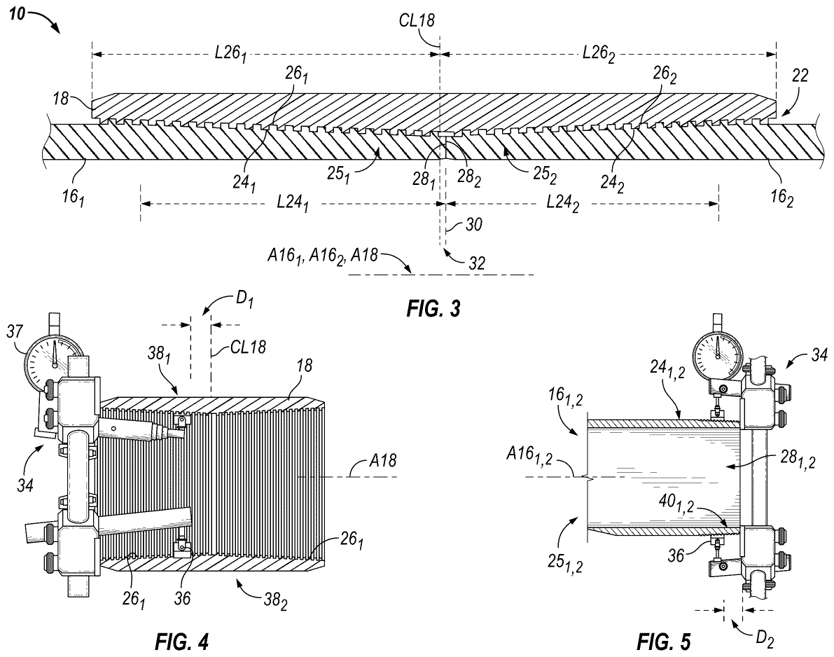

Referring now to FIG. 3, shown in a side sectional view is a portion of the threaded connection 22 of FIG. 2. In this example, threads 24₁ are shown formed on a pin end 25₁ of tubular 16₁. Similarly, tubular 16₂ is shown having threads 24₂ on its outer surface of its pin end 25₂. Threads 26₁ are shown formed along a portion of the inner surface of coupling 18, threads 26₁ are in engagement with and complementary to threads 24₁ on pin end 25₁. Formed along an inner surface of coupling 18 are additional threads 26₂ that extend axially away from threads 26₁ to an opposing end of coupling 18. Threads 26₂ are complementary to threads 24₂ and are shown engaged with threads 24₂ to attach pin end 25₂ to coupling 18. Engagement between threads 24_{1, 2} on pin ends 25_{1, 2} and threads 26_{1, 2} on coupling 18 form the threaded connection 22. In the example shown, terminal ends 28₁, 28₂ of pin ends 25₁, 25₂ are shown in abutting contact with one another when the threaded connection 22 is formed. An interface 30 is formed by contact between the terminal ends 28_{1, 2}. Included in FIG. 3 is a centerline CL₁₈ that defines a midpoint of coupling 18 along axis A₁₈ (i.e., centerline CL₁₈ extends substantially perpendicular to axis A₁₈), in the example of FIG. 3, axes A16₁, A16₂, and A₁₈ are shown coincident with one another. In the example of FIG. 3, the interface 30 is in a plane spaced axially away from a centerline CL₁₈ of coupling 18 by an amount that defines an offset 32. The offset 32 is strategically dimensioned so that there is a greater amount of interference between threads 24₁, 26₁ than between threads 24₂, 26₂. Creating a greater interference between the threads 24₁, 26₁ than between threads 24₂, 26₂ results in a greater torque required to engage threads 24₁ with threads 26₁ than to engage 24₂ with threads 26₂ and so that the interface 30 is a distance past centerline CL₁₈. In an example, an axial length of the offset 32 ranges from about 0.2% to about 0.6% of an axial length of coupling 18 and all values within this range. Similarly, a corresponding torque required to disengage threads 24₁, 26₁ is greater than the torque for disengaging threads 24₂, 26₂. As described in more detail below, each tubular 16 has a pin end 25₁ on one of its ends, and another pin end 25₂ on an end opposite pin end 25₁. In alternatives, threads 24₁ on pin end 25₁ have substantially the same dimensions and specifications as threads 24₂ on pin end 25₂, and threads 26₁ have substantially the same dimensions and specifications as threads 26₂. A length L26₁ of threads 26₁ (“thread length”) is defined herein as the axial distance of coupling 18 on which threads 26₁ are formed, similarly, length L26₂ of threads 26₂ is defined herein as the axial distance of coupling 18 on which threads 26₂ are formed, length L24₁ of threads 24₁ is defined herein as the axial distance of pin 16₁ on which threads 24₁ are formed, and length L24₂ of threads 24₂ is defined herein as the axial distance of pin 16₂ on which threads 24₂ are formed.

Referring now to FIG. 4, shown is an example of using a gauge 34 to inspect threads 26₁ on coupling 18. Gauge 34 is also referred to herein as an ORP® gauge or a crest diameter and ovalty gauge and includes one or more contact shoes 36 for measuring an inner diameter of threads 26₁. Gauge 34 optionally includes a dial indicator 37 for visually indicating the measured diameter, in alternatives gauge 34 includes a digital display (not shown). The measurements with the gauge 34 are taken by skimming the shoes 36 along the inner circumference of the threads 26₁, while maintaining the shoes 36 a distance D₁ from centerline CL₁₈ of coupling 18. A designated portion 38₁ of the length L26₁ of threads 26₁ (FIG. 3) is being inspected by positioning the contact shoes 36 the distance D₁ from centerline CL₁₈ of coupling 18. Embodiments include inspecting threads 26₂ with the shoes 36 in the same manner as inspecting threads 26₁, and also a distance D₁ from centerline CL₁₈ of coupling 18 so that a designated portion 38₂ of the length L26₂ of threads 26₂ (FIG. 3) is being inspected by the contact shoes 36. As shown in a side partial sectional view in FIG. 5, gauge 34 is also employed for inspecting threads 24_{1, 2} on an outer surface of the pin ends 25_{1, 2}, and where contact shoe 36 is positioned a distance D₂ away from terminal ends 28_{1, 2} along axis A16₁. Designated portions 40_{1, 2} of the lengths L24_{1, 2} of threads 24_{1, 2} (FIG. 3) are being inspected by positioning the contact shoes 36 the distance D₂ from the centerline CL₁₈ of coupling 18. Distance D₂ and distance D₁ (FIG. 4) are strategically selected so that thread dimension values are obtained at a location(s) along the threads 26_{1, 2} that is(are) substantially aligned with axial location(s) along threads 24_{1, 2} when each pin end 25_{1, 2} is threadingly engaged with corresponding threads 26_{1, 2} in the coupling 18 i.e., the portions of the threads 24_{1, 2}, 26_{1, 2} being inspected with gauge 34 interface and engage with one another when the threaded connection 22 (FIG. 3) is formed; these portions of the threads 24_{1, 2}, 26_{1, 2} are alternatively referred to as corresponding portions—in this example, the designated portions 38_{1, 2}, 40_{1, 2} at least partially coincide with the corresponding portions. In an embodiment, when inspecting threads 24_{1, 2}, 26_{1, 2} centerlines of shoes 36 are aligned with distances D₁, D₂. The dimensions of threads 24_{1, 2}, 26_{1, 2} measured with gauge 34 are used when manufacturing multiple couplings 18 to ensure the dimensions of threads 24_{1, 2}, 26_{1, 2} on each of the couplings 18 and tubulars 16 are within designated tolerances, so that the string 10 that is assembled from these couplings 18 and tubulars 16 has a greater structural integrity than a string made from tubulars and couplings in which dimensions of threads on each of the tubulars and couplings are not maintained within designated tolerances. In an alternative, distance D₂ is set so that the portion of threads 24_{1, 2} being inspected are fully crested threads—in this example, the designated portions 40_{1, 2} at least partially coincide with threads 24_{1, 2} that are fully crested. In alternatives, the designated portions 40_{1, 2} are situated at a section of the fully crested threads 24_{1, 2} adjacent or proximate the terminal ends 28_{1, 2} of the tubulars 16_{1, 2}. For the purposes of discussion herein, “fully crested threads” are threads that are not truncated, flattened, or topped off, but have substantially 100% of their theoretical thread height, and which provide substantially maximum thread engagement. In alternatives, the distance D₁ and/or distance D₂ is selected to coincide with a portion of threads 24_{1, 2}, 26_{1, 2} being inspected are where a pressure barrier is formed between threads 24_{1, 2}, 26_{1, 2} when engaged as part of the threaded connection 22—in this example, the designated portions 38_{1, 2}, 40_{1, 2} at least partially coincide with threads 24_{1, 2}, 26_{1, 2} that when engaged with one another have a pressure barrier formed therebetween (“pressure barrier region”). Further in this example, the designated portions 38_{1, 2}, 40_{1, 2} are strategically located within a section of the pressure barrier region most proximate the terminal ends 28_{1, 2} or centerline CL₁₈. An advantage of inspecting the designated portions 38_{1, 2}, 40_{1, 2} of the thread lengths L24_{1, 2}, L26_{1, 2} described herein is that a substantially greater number of pins and couplings having a portion of a thread length not within the designated specification are identified and removed prior to assembly. Removing a greater number of “out of spec” pins and couplings increases the consistency in construction of the threaded connections 22 so that less time is spent disassembling threaded connections found to be defective and significantly reduces the time required to form a string 10. In another alternative, distances D₁ and D₂ are selected so that when pin ends 25_{1, 2} are threadingly engaged with the coupling 18, a maximum thread interference between threads 24_{1, 2}, 26_{1, 2} that are engaged to one another occurs at the location(s) along threads 24_{1, 2}, 26_{1, 2} that are inspected with shoe 36 of gauge 34, i.e., designated portions 38_{1, 2}, 40_{1, 2}. An example of a thread interference is that a pitch of at least a portion of threads 24_{1, 2} (or threads 26_{1, 2}) exceeds a pitch of a corresponding portion of threads 26_{1, 2} (or threads 24_{1, 2}), so that when the coupling 18 is threadingly engaged with the pin 16₁, and a portion of threads 24_{1, 2} mesh with a corresponding portion of threads 26_{1, 2}, the increased pitch of threads 24_{1, 2} (or threads 26_{1, 2}) causes an amount of elastic compression within one or both of threads 24_{1, 2}, 26_{1, 2}, to create a pressure seal along the interface where threads 24_{1, 2}, 26_{1, 2} are engaged with one another. In the following alternatives, distance D₁ ranges from about 8% to about 37% of the length L26_{1, 2} of threads 26_{1, 2}, distance D₁ ranges from about 10% to about 35% of the length L26_{1, 2} of threads 26_{1, 2}, distance D₁ ranges from about 15% to about 30% of the length L26_{1, 2} of threads 26_{1, 2}, distance D₁ ranges from about 20% to about 30% of the length L26_{1, 2} of threads 26_{1, 2}, distance D₁ is equal to any one of the aforementioned values, distance D₂ ranges from about 8% to about 37% of the length L24_{1, 2} of threads 24_{1, 2}, distance D₂ ranges from about 10% to about 40% of the length L24_{1, 2} of threads 24_{1, 2}, distance D₂ ranges from about 15% to about 30% of the length L24_{1, 2} of threads 24_{1, 2}, distance D₂ ranges from about 20% to about 30% of the length L24_{1, 2} of threads 24_{1, 2}, and distance D₂ is equal to any one of the aforementioned values.

In examples, threads 24_{1, 2} are formed to be same or substantially the same as American Petroleum Institute (“API”) buttress thread form. Optionally, threads 26_{1, 2} are also formed to be the same or substantially the same as API buttress thread forms. In alternatives, threads 24_{1, 2} and threads 26_{1, 2} are API compatible. An example of standards and specifications for API buttress threads is found in API Specification 5CT/5B, 10th Edition (2019), which is incorporated by reference herein in its entirety and for all purposes.

TABLE 1
(4.5 in.)

| | | Pitch | | | | Hand | |
|---|---|---|---|---|---|---|---|
| | | Diameter | PD | PD | | Tight | Thread |
| | Size | (“PD”) | Location | tolerance | Taper/ft. | Standoff | Interference |
| | (in.) | (in.) | (in.) | (in.) | (in.) | (in) | (in.) |
| API min | 4.5 | 4.454 | 1.884 | 0.00 | 0.75 | 0.4 | 0.025 |
| Coupling | | | | | | | |
| API max | 4.5 | 4.46025 | 1.884 | 0.00625 | 0.75 | 0.3 | 0.01875 |
| Coupling | | | | | | | |
| Coupling | 4.5 | 4.454 | 2.0176 | 0.00 | 0.780 | 0.266 | 0.0173 |
| min | | | | | | | |
| Coupling | 4.5 | 4.457 | 2.0176 | 0.003 | 0.780 | 0.220 | 0.0143 |
| max | | | | | | | |

TABLE 2
(5.5 in.)

| | | Pitch | | | | Hand | |
|---|---|---|---|---|---|---|---|
| | | Diameter | PD | PD | | Tight | Thread |
| | Size | (“PD”) | Location | tolerance | Taper/ft. | Standoff | Interference |
| | (in.) | (in.) | (in.) | (in.) | (in.) | (in) | (in.) |
| API min | 5.5 | 5.454 | 1.784 | 0.00 | 0.75 | 0.5 | 0.03125 |
| Coupling | | | | | | | |
| API max | 5.5 | 5.46025 | 1.784 | 0.00625 | 0.75 | 0.4 | 0.025 |
| Coupling | | | | | | | |
| Coupling | 5.5 | 5.454 | 1.9250 | 0.00 | 0.780 | 0.359 | 0.0233 |
| min | | | | | | | |
| Coupling | 5.5 | 5.457 | 1.9250 | 0.003 | 0.780 | 0.313 | 0.0203 |
| max | | | | | | | |

In Tables 1 and 2 above are examples of maximum and minimum values of pitch diameter, pitch diameter tolerance, taper per axial length, hand tight standoff, and thread interference of API standard buttress threads and threads on the disclosed coupling 18. Table 1 is for tubulars having a 4.5 inch nominal size and Table 2 is for tubulars having 5.5 inch nominal size. The values in Tables 1 and 2 are from an embodiment of the threaded connection 22 having a value of the offset 32 being 0.0. Included in these tables is a comparison between threads 26_{1, 2} on the disclosed coupling 18 and API threads. The values of minimum pitch diameters for the disclosed threads 26_{1, 2} and API threads are substantially the same for both nominal sizes, the maximum pitch diameters differ by 0.003 in. for the 4.5 size tubular and differ by 0.003 inches for the 5.5 nominal pipe size. The combination of the offset disclosed above in combination with these tight tolerance differences provides an advantage that the pipe string 10 is assembled in less time as fewer connections will require reassembly than strings having couplings with larger tolerances of these values. In examples, these values of tolerance are maintained for the entire lengths of threads 24_{1, 2} and threads 26_{1, 2} on all couplings 18 and threads 24_{1, 2} on all tubulars 16_{1, 2} within the string 10. In the present disclosure “tolerance” is defined as a range of allowable dimensions as dictated by a particular specification, such as the API Specification 5CT/5B or a design criteria established by a tubular manufacturer. Example tolerance values of the coupling 18 are provided in Tables 1 and 2 above. Embodiments exist in which tolerance values of the pin ends 25_{1, 2} are less than tolerance values of the coupling 18, tolerance values of the pin ends 25_{1, 2} are less than tolerance values of buttress threads as specified by the API Specification 5CT/5B, or tolerance values of the pin ends 25_{1, 2} are about one half of tolerance values of buttress threads as specified by the API Specification 5CT.

Referring back to FIG. 3, in a non-limiting example of operation, threads 24_{1, 2}, 26_{1, 2} on couplings 18 and tubulars 16_{1, 2} are inspected with the shoe 36 on the gauge 34 as described above. The information gathered using the gauge 34 is compared with standards from a designated specification, such as API Specification 5CT/5B, or an otherwise acceptable design criteria. Threads 24_{1, 2}, 26_{1, 2} with dimensions not in compliance with the designated specification are deemed to have failed the inspection. Threads 24_{1, 2}, 26_{1, 2} also can fail inspection if, by using the gauge 34 or by a visual inspection, they are found to have a discontinuity of surface, i.e., a protrusion, a burr, a depression, a cut, a groove, etc. that could interfere with thread engagement. The couplings 18 and tubulars 16_{1, 2} having threads 24_{1, 2}, 26_{1, 2} that pass the inspection are included in the string 10 (FIG. 1), and couplings 18 and tubulars 16_{1, 2} with those out of compliance threads 24_{1, 2}, 26_{1, 2} are rejected and are not included in the string 10. Criteria for being not in compliance with the designated specification includes threads 24_{1, 2}, 26_{1, 2} having a thread dimension (pitch, height, bearing angle, etc.) that is not within the standards (included tolerance values) dictated by the designated specification or design criteria. For the purposes of discussion in this example, pin end 25₁ is referred to as a first pin end of tubular 16₁ and pin end 25₂ is referred to as a second pin end of tubular 16₂. Further in this example, coupling 18 is attached to pin end 25₁ at a location different from where the wellbore 12 (FIG. 1) is located, such as in a mill or manufacturing facility; and the second pin end 25₂ of tubular 16₂ is attached to the coupling 18 at the wellsite in a manner such as that illustrated in FIG. 1, i.e. inserted into the end of coupling 18 opposite its connection to pin end 25₁ and tubular 16₂ is rotated while tubular 16₁ is held rotationally stable. An advantage of the offset 32 that causes greater interference between threads 24₁, 26₁ than threads 24₂, 26₂ so that engagement torque between the first pin end 25₁ and coupling 18 exceeds that between the second pin 25₂ and coupling 18, results in the ability to fully engage the second pin 25₂ with coupling 18 without causing coupling 18 to rotate relative to first pin end 25₁. Further shown in FIG. 3 is a thread relief 33 which is formed along an inner surface of coupling 18 and strategically located to be adjacent to the interface 30, thread relief receives ends of threads 24_{1, 2} when the ends 28_{1, 2} are in abutting contact.

In another example of forming the string 10 (FIGS. 1-3), coupling 18, as noted above, is threadingly engaged onto pin end 25₁ of a first tubular 16₁ at a location, such as a mill that is separate from where the wellbore 12 is located (i.e. the wellsite). In this example, the pin end 25₁ of the first tubular 16₁ on which the coupling 18 mounts is referred to as a “mill end” and the opposite end of the first tubular 16₁ (pin end 25₂) is referred to as the “field end.” Similarly, connection between the coupling 18 and mill end (pin end 25₁) is referred to as a mill connection, and connection between the field end (pin end 25₂) and coupling 18 is referred to as a field connection. At the wellsite, the string 10 is formed by inserting field end of a first tubular 16₁ into the wellbore 12 (such as through a main bore of a blowout preventer) so that the mill end of the first tubular 16₁ with the attached coupling 18 is accessible from surface, securing the first tubular 16₁ with tongs or a ram (not shown), threading a field end of a second tubular 16₂ into the coupling 18 attached to the first tubular 16₁, and rotating the second tubular 16₂ with the tongs to form the threaded connection 22. This process is repeated with a number of subsequent tubulars 3−n to form the string 10 Another advantage of the present disclosure is that, when forming a string 10, the values of make-up torque exerted onto the second tubular 16₂ or coupling 18 to form each of the connections 22 remain significantly more consistent than in currently known connections. More specifically, plots of tubular rotation versus measured torque recorded when forming a string 10 are surprisingly identical, these plots are sometimes referred to in the art as “torque turn charts.” Optionally, a compound, e.g., lubricant, grease, pipe dope, etc., is applied to threads 24_{1, 2} and/or threads 26_{1, 2} prior to threadingly engaging pin ends 25_{1, 2} with coupling 18. In alternatives, the thread compound applied to threads 24₁ differs from a thread compound applied to threads 24₂, the thread compound applied to threads 26₁ differs from a thread compound applied to threads 26₂, the thread compound applied to threads 24₁ and threads 26₁ is the same but differs from a thread compound applied to threads 24₂ and/or threads 26₂, and the thread compound applied to threads 24₂ and threads 26₂ is the same but differs from a thread compound applied to threads 24₁ and/or threads 26₁. Examples of differences in the thread compound include differences in viscosity and/or density. Not to be limited by theory, but applying a thread compound to threads 24₂ and or threads 26₂ having properties that reduce friction or resistance to relative rotation more than a thread compound that is applied to threads 24₁ and or threads 26₁ results in a reduced make up torque required for the field connection, and lessens the probability that the mill connection will be rotated when forming the field connection. In Table 3 below are properties of example pipe compounds. In a non-limiting example, the first compound is applied to threads 24₂ and threads 26₂, and the second compound, which includes a petroleum base with a complex soap, is applied to threads 24₁ and threads 26₁. In an alternative, the interference between threads 24₁ and threads 26₁ on the mill end of the coupling 18 is greater than an interference between threads 24₂ on pin end 25₂ and threads 26₂ on the mill end of the coupling 18. In this example, the torque exerted when engaging threads 24₁ with threads 26₁ to threadingly attach pin 16₁ to the mill end of coupling 18 exceeds the torque exerted when attaching pin 16₂ to the field end of coupling 18, which further lessens the probability that the mill connection will be rotated when forming the field connection.

TABLE 3

| | First Compound | Second Compound |
|---|---|---|
| Dropping Point (° F.) | 350 | 450 |
| Flash Point (° F.) | 392 | >450 |
| Penetration | 310-330 | 325-350 |
| Density (lbm/gal) | 10.2 | 10.4 |
| Friction Factor | 0.9 | 0.9 |

In a non-limiting example, a 5.5 inch 20 pound connection made of HP-110 grade steel with a minimum yield strength of 125 ksi and a minimum tensile strength of 130 ksi makes up a connection having a 6.3 inch outer diameter, a 4.778 inch inner diameter, a length of 8.275, a makeup loss of 4.103 inches on the field end, and has a pitch of 5 threads per inch. The torques for this connection are a minimum of 13,000 ft-lbf, a maximum of 20,000 ft-lbf, a maximum operational limit of 32,000 ft-lbf, a yield of 36,000 ft-lbf, and an operational safety factor of 89%.

The present invention described herein, therefore, is well adapted to carry out the objects and attain the ends and advantages mentioned, as well as others inherent therein. While one or more embodiments have been given for purposes of disclosure, numerous changes exist in the details of procedures for accomplishing the desired results. These are intended to be encompassed within the spirit of the present invention disclosed herein and the scope of the appended claims.

What is claimed is:

1. A method of wellbore operations comprising:
obtaining annular couplings with threaded lengths, and where designated portions of the threaded lengths have each passed an inspection;
forming a tubular string by threadingly engaging the threaded lengths of the couplings with threaded ends of tubular members; and
inserting the tubular string into the wellbore.

2. The method of claim 1, wherein the threaded lengths each comprise a thread formed on an inner surface of the annular coupling, the inspection comprises comparing a diameter of the thread with a specified diameter of the thread.

3. The method of claim 1, wherein the threaded lengths comprise first threaded lengths, wherein the designated portions comprise first designated portions, wherein second threaded lengths with second designated portions are on threaded ends of the tubular members, and wherein the second designated portions have each passed the inspection.

4. The method of claim 1, wherein the threaded lengths comprise first threaded lengths, wherein the designated portions comprise first designated portions, wherein second threaded lengths with second designated portions are on threaded ends of the tubular members, and wherein the first and second designated portions are in threaded engagement with one another when the tubular string is formed.

5. The method of claim 1, wherein the threads on the designated portions are fully crested threads.

6. The method of claim 1, wherein each of the couplings comprises a mill end and a field end, and wherein the step of forming the tubular string comprises applying a first torque to mount the mill end of a one of the couplings with a mill end of a one of the tubular members, applying a second torque to mount the field end of the coupling with a field end of another one of the tubular members, wherein the first torque exceeds the second torque.

7. The method of claim 6, wherein an interference between threads on the mill end of the coupling and mill end of a one of the tubulars exceeds an interference between threads on the field end of coupling and the field end of the another one of the tubular members.

8. The method of claim 6, further comprising applying a first pipe compound to the threads on the mill end of the coupling and applying a second pipe compound to the threads on the field end of the coupling, wherein a viscosity of the first pipe compound exceeds a viscosity of the second pipe compound.

9. The method of claim 6, wherein a taper of the threads on the mill end of the coupling differs from a taper of the threads on the mill end of a one of the tubulars, and wherein a taper of the threads on the field end of coupling is different from a taper of threads on the field end of the another one of the tubular members.

10. The method of claim 1, wherein portions of the tubular members within the couplings interface one another at an axial location that is offset from an axial midpoint of the coupling.

11. The method of claim 1, wherein the designated portion coincides with a portion of the thread length where a pressure barrier is formed in an interface between threads on the coupling and threads on the pin.

12. A method of wellbore operations comprising:
a. obtaining annular coupling having an inner thread with a thread length;
b. gathering information about the thread along a designated portion of the thread length;
c. accepting the annular coupling if the information complies with standards from a designated specification;
d. repeating steps (a)-(c) to obtain a multiplicity of accepted annular couplings;
e. forming a tubular string with annular couplings; and
f. inserting the tubular string into the wellbore.

13. The method of claim 12, wherein the tubular string comprises tubular members threadingly engaged to one another with the accepted annular couplings.

14. The method of claim 13, wherein threads having thread lengths are formed on ends of the tubulars, the method further comprising gathering information about each of the threads on the tubulars along portions of the thread lengths on the tubulars, and accepting tubulars having threads that comply with the standards, wherein only accepted tubulars are used to form the tubular string.

15. The method of claim 14, wherein the portions of the thread lengths on the tubulars mesh with the designated portion of the thread length on the coupling when attached to one another.

16. The method of claim 12, wherein each of the couplings comprise a mill end and a field end, and wherein a torque applied to engage a tubular to the mill end exceeds a torque applied to engage another tubular to the field end.

17. The method of claim 12, wherein each of the couplings comprise a mill end and a field end, wherein a mill end tubular is attached to the mill end and a field end tubular is attached to the field end, and wherein the mill end tubular and field end tubular abut one another inside the coupling at an interface that is between a centerline of the coupling and the field end.

18. The method of claim 12, wherein the designated portion of the thread length engages threads on the tubular that are fully crested.

19. The method of claim 12, wherein the designated portion of the thread length is proximate a centerline of the coupling.

20. The method of claim 12, wherein the designated specification comprises API Specification 5CT/5B.
